(19) United States
(12) Patent Application Publication
(10) Pub. No.: US 2026/0319296 A1
(43) Pub. Date: Oct. 15, 2026

(54) DISPLAY APPARATUS WITH CROSS-COLUMN DIMMING BLOCK DRIVING

(71) Applicant: SAMSUNG ELECTRONICS CO., LTD., Suwon-si (KR)

(72) Inventors: Seungyong SHIN, Suwon-si (KR); Myungjoon KIM, Suwon-si (KR); Sujin KIM, Suwon-si (KR); Hyungjin KIM, Suwon-si (KR); Yongmin JUNG, Suwon-si (KR)

(73) Assignee: SAMSUNG ELECTRONICS CO., LTD., Suwon-si (KR)

(21) Appl. No.: 19/692,815

(22) Filed: May 29, 2026

Related U.S. Application Data
(63) Continuation of application No. PCT/KR2024/017723, filed on Nov. 11, 2024.

(30) Foreign Application Priority Data
Dec. 29, 2023 (KR) 10-2023-0197856

(51) Int. Cl. G02F 1/1335; H05B 45/10

(52) U.S. Cl. CPC G02F 1/133612; H05B 45/10

(57) ABSTRACT

A display apparatus includes a substrate; a plurality of dimming blocks arranged in a plurality of rows and a plurality of columns on the substrate, each of the plurality of dimming blocks including a plurality of light-emitting devices; a plurality of driving devices configured to drive at least two of the plurality of dimming blocks, each of the plurality of driving devices being configured to drive at least two dimming blocks arranged in different columns; memory storing instructions; and at least one processor configured to control the plurality of driving devices. The instructions, when executed by the at least one processor individually or collectively, cause the at least one processor to control the plurality of driving devices to drive the plurality of dimming blocks arranged in a single row simultaneously.

### CROSS-REFERENCE TO RELATED APPLICATIONS

This application is a bypass continuation application of International Application No. PCT/KR2024/017723, filed on Nov. 11, 2024, which claims priority to Korean Patent Application No. 10-2023-0197856, filed on Dec. 29, 2023, in the Korean Intellectual Property Office, the disclosures of which are incorporated by reference herein in their entireties.

### BACKGROUND

### 1. Field

The disclosure relates to a display apparatus, and more particularly, to a display apparatus including a liquid crystal panel and a backlight unit (BLU).

### 2. Description of Related Art

In general, a display apparatus is a type of an output apparatus that converts obtained or stored electrical information into visual information and displays the visual information to a user. The display apparatus is used in various fields, such as home or workplace.

The display apparatus includes a backlight unit (BLU) that provides light to a liquid crystal panel, and the backlight unit includes a plurality of point light-emitting devices configured to independently emit light. The light-emitting devices include light-emitting diodes (LEDs) or organic light-emitting diodes (OLEDs).

A local dimming technology in the backlight unit of an LED television (TV) is a key technology for improving a contrast ratio of a display. A local dimming system may divide a display screen into multiple zones and independently control a current for each zone based on an input image. Accordingly, the local dimming system may reduce a current when the input image is dark, and increase the current when the input image is bright, thereby effectively improving the contrast ratio.

In general, in driving systems such as active matrix and passive matrix systems, dimming blocks driven by a single driving device are arranged in the same column for sequential driving. In this case, depending on the arrangement of dimming blocks on the substrate, the number of dimming blocks driven by a single driving device may decrease, resulting in an increase in the number of required driving devices.

### SUMMARY

Provided is a display apparatus that may reduce the number of driving devices by arranging dimming blocks driven by a single driving device in different columns and prevent image quality deterioration by driving dimming blocks arranged in the same row simultaneously.

Additional aspects will be set forth in part in the description which follows and, in part, will be apparent from the description, or may be learned by practice of the presented embodiments.

According to an aspect of the disclosure, a display apparatus may include a substrate; a plurality of dimming blocks arranged in a plurality of rows and a plurality of columns on the substrate, each of the plurality of dimming blocks including a plurality of light-emitting devices; a plurality of driving devices configured to drive at least two of the plurality of dimming blocks, each of the plurality of driving devices being configured to drive at least two dimming blocks arranged in different columns; memory storing instructions; and at least one processor configured to control the plurality of driving devices. The instructions, when executed by the at least one processor individually or collectively, cause the at least one processor to control the plurality of driving devices to drive the plurality of dimming blocks arranged in a single row simultaneously.

The instructions, when executed by the at least one processor individually or collectively, cause the at least one processor to control the plurality of driving devices to sequentially drive dimming blocks of the plurality of dimming blocks arranged in different rows.

The instructions, when executed by the at least one processor individually or collectively, cause the at least one processor to control the plurality of driving devices to drive a first set of dimming blocks of the plurality of dimming blocks arranged in a first row simultaneously, and, subsequent to the first set of dimming blocks arranged in the first row being simultaneously driven, drive a second set of dimming blocks of the plurality of dimming blocks arranged in a second row simultaneously, the second row being adjacent to the first row.

Each of the plurality of driving devices may be configured to drive four dimming blocks arranged in two adjacent columns and two adjacent rows.

Each of the plurality of driving devices may be configured to supply a driving current to the four dimming blocks arranged in the two adjacent columns and the two adjacent rows.

Each of the plurality of driving devices may be configured to drive six dimming blocks arranged in two adjacent columns and three adjacent rows.

Each of the plurality of driving devices may be configured to supply a driving current to the six dimming blocks arranged in the two adjacent columns and the three adjacent rows.

Each of the plurality of driving devices may be disposed on an upper surface or a lower surface of the substrate.

Each of the plurality of dimming blocks may include a defined number of light-emitting devices.

According to an aspect of the disclosure, a display apparatus may include: a substrate including a plurality of sub-substrates; a plurality of dimming blocks arranged in a plurality of rows and a plurality of columns on each of the plurality of sub-substrates, each of the plurality of dimming blocks including a plurality of light-emitting devices; a plurality of driving devices configured to drive at least two of the plurality of dimming blocks, each of the plurality of driving devices may be configured to drive at least two dimming blocks arranged in different columns; memory storing instructions; and at least one processor configured to control the plurality of driving devices,

The instructions, when executed by the at least one processor individually or collectively, cause the at least one processor to control the plurality of driving devices to: drive the plurality of dimming blocks arranged in a single row of the plurality of rows simultaneously, and sequentially drive the plurality of dimming blocks arranged in different rows.

According to an aspect of the disclosure, a method for sequentially driving a plurality of dimming blocks arranged in a plurality of rows on a substrate of a display apparatus may be provided. The method may include: driving dimming blocks of a plurality of dimming blocks arranged in a first row simultaneously; and subsequent to the dimming blocks arranged in the first row being simultaneously driven, drive dimming blocks of the plurality of dimming blocks arranged in a second row simultaneously.

The plurality of dimming blocks may be driven by a plurality of driving devices.

The dimming blocks may be arranged in the first row are simultaneously driven by a first set of the plurality of driving devices.

The second row may be adjacent to the first row.

Each of the plurality of dimming blocks may include a plurality of light-emitting devices.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an example of an exterior of a display apparatus according to an embodiment;

FIG. 2 illustrates an example of a structure of the display apparatus according to an embodiment;

FIG. 3 illustrates an example of a liquid crystal panel included in the display apparatus according to an embodiment;

FIG. 4 illustrates an example of a backlight unit (BLU) included in the display apparatus according to an embodiment;

FIG. 5 illustrates a state in which a plurality of light-emitting diodes (LEDs) of the backlight unit are divided into dimming blocks according to an embodiment;

FIG. 6 illustrates a control block diagram of the display apparatus according to an embodiment;

FIG. 7 illustrates an example of an arrangement of dimming blocks driven by each driving device according to an embodiment;

FIG. 8 illustrates an example of an improved arrangement of dimming blocks driven by each driving device according to an embodiment.

FIG. 9 illustrates the number of driving devices required according to an arrangement of dimming blocks driven by each driving device according to an embodiment;

FIGS. 10A and 10B illustrate dimming blocks in an improved arrangement being driven according to a sequential driving method according to an embodiment; and

FIGS. 11A and 11B illustrate dimming blocks arranged in the same row being driven simultaneously according to an embodiment.

### DETAILED DESCRIPTION

Various embodiments and the terms used therein are not intended to limit the technology disclosed herein to specific forms, and the disclosure should be understood to include various modifications, equivalents, and/or alternatives to the corresponding embodiments.

It is to be understood that each embodiment described herein may apply to one or more other embodiments.

In describing the drawings, similar reference numerals may be used to designate similar constituent elements.

Terms used herein are for the purpose of describing the embodiments and are not intended to restrict and/or to limit the disclosure. The singular expressions herein may include plural expressions, unless the context clearly dictates otherwise. The terms “comprises”, “includes” and “has” are intended to indicate that there are features, numbers, steps, operations, elements, parts, or combinations thereof described in the specification, and do not exclude the presence or addition of one or more other features, numbers, steps, operations, elements, parts, or combinations thereof.

When an element (e.g., a first element) is referred to as being “coupled,” or “connected” to another element (e.g., a second element), the first element may be connected to the second element, directly, indirectly, or through a third element.

It will be understood that, although the terms first, second, or the like, may be used herein to describe various components, these components should not be limited by these terms. These terms are only used to distinguish one component from another. For example, without departing from the technical spirit or essential features of the disclosure, a first element may be referred to as a second element, and also a second element may be referred to as a first element. The term “and/or” includes any and all combinations of one or more of the associated listed items.

Hereinafter, embodiments according to the disclosure are described in detail with reference to accompanying drawings.

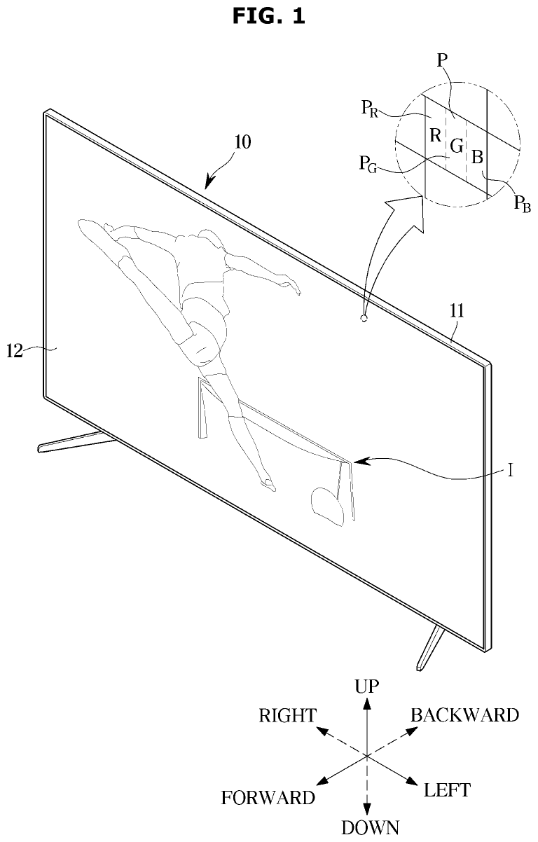

FIG. 1 illustrates an example of an exterior of a display apparatus according to an embodiment.

Referring to FIG. 1, a display apparatus 10 is a device that processes an image signal received from an outside and visually displays the processed image. Hereinafter, a case in which the display apparatus 10 is a television (TV) is exemplified, but the disclosure is not limited thereto. For example, the display apparatus 10 may be implemented in various forms, such as a monitor, a portable multimedia device, and a portable communication device, and the display apparatus 10 is not limited in its shape as long as visually displaying an image.

The display apparatus 10 may be a large format display (LFD) installed outdoors, such as a roof of a building or a bus stop. The outdoor is not limited to the outside of a building, and thus the display apparatus 10 according to an embodiment may be installed in any places as long as the display apparatus is accessed by a large number of people, even indoors, such as subway stations, shopping malls, movie theaters, companies, and stores.

The display apparatus 10 may receive content including video signals and audio signals from various content sources, and output video and audio corresponding to the video signals and the audio signals. For example, the display apparatus 10 may receive content data through a broadcast reception antenna or a cable, receive content data from a content playback device, or receive content data from a content providing server of a content provider.

As shown in FIG. 1, the display apparatus 10 may include a main body 11, and a screen 12 provided to display an image I.

The main body 11 may form an appearance of the display apparatus 10, and a component configured to allow the display apparatus 10 to display the image I and to perform various functions may be provided in the main body 11. Although the main body 11 shown in FIG. 1 is in the form of a flat plate, the shape of the main body 11 is not limited thereto. For example, the main body 11 may have a curved plate shape.

The screen 12 may be formed on a front surface of the main body 11, and display the image I. For example, the screen 12 may display a still image or a moving image. Further, the screen 12 may display a two-dimensional plane image or a three-dimensional image using binocular parallax of the user.

The screen 12 may include a liquid crystal panel provided to transmit or block light emitted from a backlight unit (BLU).

A plurality of pixels P may be formed on the screen 12, and the image I displayed on the screen 12 may be formed by a combination of light emitted from the plurality of pixels P. For example, the image I may be formed on the screen 12 by combining light emitted from the plurality of pixels P as a mosaic.

Each of the plurality of pixels P may emit different brightness and different color of light. In order to emit different color of light, the plurality of pixels P may include sub-pixels PR, PG, and PB, respectively.

The sub-pixels PR, PG, and PB may include a red sub-pixel PR emitting red light, a green sub-pixel PG emitting green light, and a blue sub-pixel PB emitting blue light. For example, the red light may represent a light ray having a wavelength of approximately 700 nm (nanometers, one billionth of a meter) to 800 nm, the green light may represent a light ray having a wavelength of approximately 500 nm to 600 nm, and the blue light may represent a light ray having a wavelength of approximately 400 nm to 500 nm.

By combining the red light of the red sub-pixel PR, the green light of the green sub-pixel PG and the blue light of the blue sub-pixel PB, each of the plurality of pixels P may emit different brightness and color of light.

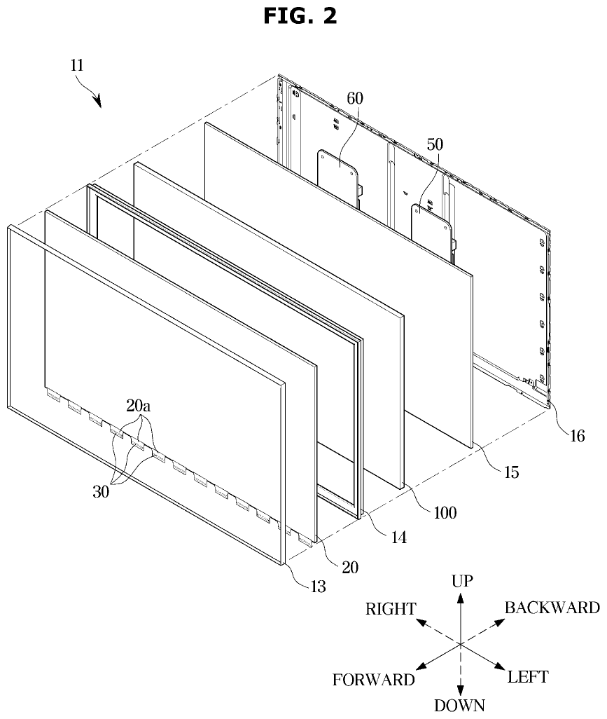

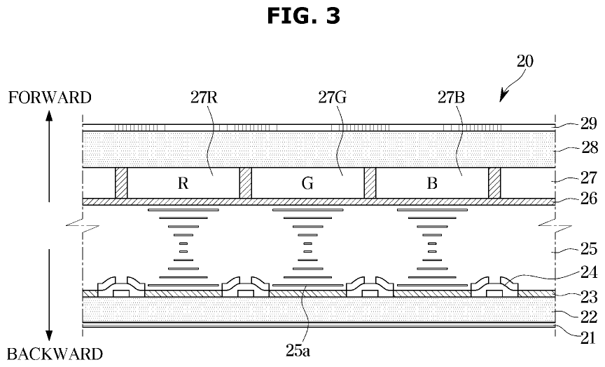

FIG. 2 illustrates an example of a structure of the display apparatus 10 according to an embodiment, and FIG. 3 illustrates an example of a liquid crystal panel included in the display apparatus 10 according to an embodiment.

As shown in FIG. 2, various components configured to generate the image I on the screen S may be provided inside the main body 11.

For example, the main body 11 may include a backlight unit 100 that is a surface light source, a liquid crystal panel 20 configured to block or transmit light emitted from the backlight unit 100, a control assembly 50 configured to control an operation of the backlight unit 100 and the liquid crystal panel 20, and a power assembly 60 configured to supply power to the backlight unit 100 and the liquid crystal panel 20. Further, the main body 11 may include a bezel 13, a frame middle mold 14, a bottom chassis 15 and a rear cover 16 which are provided to support the liquid crystal panel 20, the backlight unit 100, the control assembly 50, and the power assembly 60.

The backlight unit 100 may include a point light source configured to emit white light. The backlight unit 100 may refract, reflect, and scatter light to convert the light emitted from the point light source into uniform surface light. As described above, the backlight unit 100 may refract, reflect, and scatter light emitted from the light source, thereby emitting uniform surface light toward the front side.

Hereinafter, the backlight unit 100 will be described in detail.

The liquid crystal panel 20 may be provided in front of the backlight unit 100 and block or transmit light emitted from the backlight unit 100 to form the image I.

A front surface of the liquid crystal panel 20 may form the screen S of the display apparatus 10 described above, and the liquid crystal panel 20 may form the plurality of pixels P. In the liquid crystal panel 20, the plurality of pixels P may independently block or transmit light of the backlight unit 100. Further, the light transmitted through the plurality of pixels P may form the image I displayed on the screen S.

For example, as shown in FIG. 3, the liquid crystal panel 20 may include a first polarizing film 21, a first transparent substrate 22, a pixel electrode 23, a thin film transistor 24, a liquid crystal layer 25, a common electrode 26, a color filter 27, a second transparent substrate 28, and a second polarizing film 29.

The first transparent substrate 22 and the second transparent substrate 28 may fix and support the pixel electrode 23, the thin film transistor 24, the liquid crystal layer 25, the common electrode 26, and the color filter 27. The first and second transparent substrates 22 and 28 may be formed of tempered glass or transparent resin.

The first polarizing film 21 and the second polarizing film 29 may be provided on the outside of the first and second transparent substrates 22 and 28. Each of the first polarizing film 21 and the second polarizing film 29 may transmit a specific polarized light ray and block (reflect or absorb) other polarized light rays. For example, the first polarizing film 21 may transmit a light ray polarized in a first direction and block (reflect or absorb) other polarized light rays. In addition, the second polarizing film 29 may transmit a light ray polarized in a second direction and block (reflect or absorb) other polarized light rays. In this case, the first direction and the second direction may be perpendicular to each other. As a result, the polarized light passing through the first polarizing film 21 may not directly pass through the second polarizing film 29.

The color filter 27 may be provided on an inner side of the second transparent substrate 28. The color filter 27 may include a red filter 27R transmitting red light, a green filter 27G transmitting green light, and a blue filter 27B transmitting blue light. The red filter 27R, the green filter 27G, and the blue filter 27B may be disposed parallel to each other. A region, in which the color filter 27 is formed, may correspond to the pixel P described above. A region, in which the red filter 27R is formed, may correspond to the red sub-pixel PR, a region, in which the green filter 27G is formed, may correspond to the green sub-pixel PG, and a region, in which the blue filter 27B is formed, may correspond to the blue sub-pixel PB.

The pixel electrode 23 may be provided on an inner side of the first transparent substrate 22, and the common electrode 26 may be provided on an inner side of the second transparent substrate 28. The pixel electrode 23 and the common electrode 26 may be formed of a metal material through which electricity is conducted, and the pixel electrode 23 and the common electrode 26 may generate an electric field to change an arrangement of liquid crystal molecules 115a forming the liquid crystal layer 25 to be described below.

The thin film transistor (TFT) 24 may be provided in an inner side of the first transparent substrate 22. The TFT 24 may be turned on (closed) or turned off (open) according to image data provided from a panel driver 30. In addition, an electric field may be formed or removed between the pixel electrode 23 and the common electrode 26 depending on the turning on (closed) or turning off (open) of the TFT 24.

The liquid crystal layer 25 may be formed between the pixel electrode 23 and the common electrode 26, and the liquid crystal layer 25 may be filled with the liquid crystal molecules 25a. The liquid crystal may exhibit an intermediate state between a solid (crystal) and a liquid. The liquid crystal may exhibit optical properties according to changes in an electric field. For example, in the liquid crystal, the orientation of molecules forming the liquid crystal may change according to a change in an electric field. As a result, the optical properties of the liquid crystal layer 25 may vary depending on the presence or absence of the electric field passing through the liquid crystal layer 25. For example, the liquid crystal layer 25 may rotate a polarization direction of light around an optical axis depending on the presence or absence of an electric field. Accordingly, the polarized light passing through the first polarizing film 21 may rotate a polarization direction thereof while passing through the liquid crystal layer 25 and may pass through the second polarizing film 29.

A cable 20a may be configured to transmit image data to the liquid crystal panel 20, and a display driver integrated circuit (DDI) (hereinafter referred to as ‘panel driver’) 30 configured to process digital image data and output an analog image signal may be provided at one side of the liquid crystal panel 20.

The cable 20a may electrically connect the control assembly 50/the power assembly 60 to the panel driver 30, and may also electrically connect the panel driver 30 to the liquid crystal panel 20. The cable 20a may include a flexible flat cable or a film cable that is bendable.

The panel driver 30 may receive image data and power from the control assembly 50 and/or the power assembly 60 through the cable 20a. The panel driver 30 may transmit the image data and a driving current to the liquid crystal panel 20 through the cable 20a.

In addition, the cable 20a and the panel driver 30 may be integrally implemented as a film cable, a chip on film (COF), or a tape carrier package (TCP). In other words, the panel driver 30 may be arranged on the cable 20a. However, the disclosure is not limited thereto, and the panel driver 30 may be arranged on the liquid crystal panel 20.

The control assembly 50 may include a control circuit configured to control an operation of the liquid crystal panel 20 and the backlight unit 100. The control circuit may process video signals and/or audio signals received from an external content source. The control circuit may transmit image data to the liquid crystal panel 20, and transmit dimming data to the backlight unit 100.

The power assembly 60 may include a power circuit configured to supply power to the liquid crystal panel 20 and the backlight unit 100. The power circuit may supply power to the control assembly 50, the backlight unit 100, and the liquid crystal panel 20.

The control assembly 50 and the power assembly 60 may be implemented as a printed circuit board and various circuits mounted on the printed circuit board. For example, the power circuit may include a capacitor, a coil, a resistance element, a processor, and a power circuit board on which the capacitor, the coil, the resistance element, and the processor are mounted. Further, the control circuit may include a memory, a processor, and a control circuit board on which the memory and the processor are mounted.

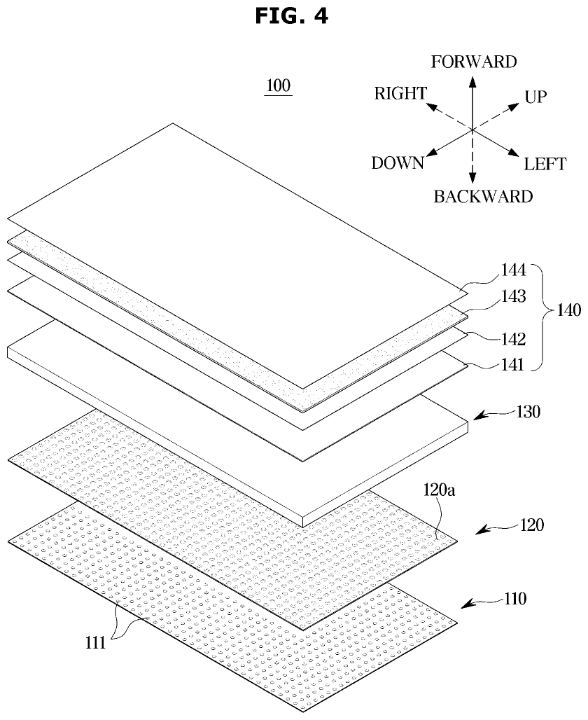

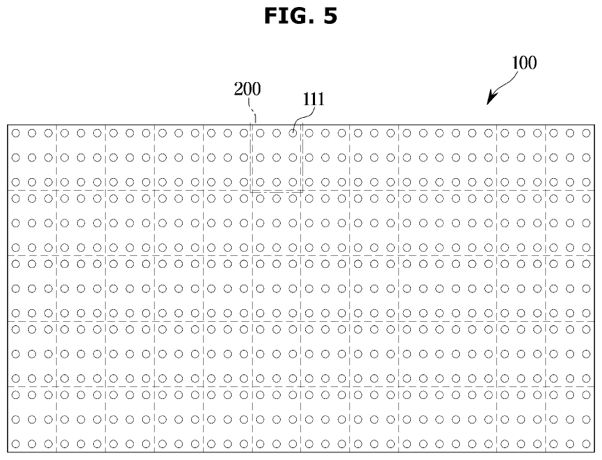

FIG. 4 illustrates an example of the backlight unit 100 included in the display apparatus 10 according to an embodiment, and FIG. 5 illustrates a state in which a plurality of light-emitting diodes (LEDs) of the backlight unit 100 according to an embodiment is divided into dimming blocks.

As shown in FIG. 4, the backlight unit 100 may include a light source module 110 configured to generate light, a reflective sheet 120 configured to reflect light, a diffuser plate 130 configured to uniformly diffuse light, and an optical sheet 140 configured to improve a luminance of light that is emitted.

The light source module 110 may include a plurality of light-emitting devices 111 configured to emit light, and a substrate 112 provided to support and/or fix the plurality of light-emitting devices 111.

The plurality of light-emitting devices 111 may be disposed in a predetermined pattern to emit light with the uniform luminance. The plurality of light-emitting devices 111 may be disposed in such a way that a distance between one light source and light sources adjacent thereto is the same.

For example, as shown in FIG. 4, the plurality of light-emitting devices 111 may be disposed in rows and columns. Accordingly, the plurality of light sources may be disposed to form an approximately square by four adjacent light sources. In addition, any one light source may be disposed adjacent to four light sources, and a distance between one light source and four adjacent light sources may be approximately the same.

According to embodiments, the plurality of light sources may be disposed to form an approximately equilateral triangle by three adjacent light sources. In this case, one light source may be disposed adjacent to six light sources, and a distance between one light source and six adjacent light sources may be approximately the same.

However, the pattern in which the plurality of light-emitting devices 111 are disposed is not limited to the pattern described above, and the plurality of light-emitting devices 111 may be disposed in various patterns to emit light with the uniform luminance.

The light-emitting device 111 may employ an element (a device) configured to emit monochromatic light (light of a specific wavelength, for example, blue light) or white light (for example, light of a mixture of red light, green light, and blue light) in various directions by receiving power. For example, the light-emitting device 111 may include a light-emitting diode (LED). The LED may be implemented in various sizes, and may include a mini-LED and/or micro-LED.

The substrate 112 may fix the plurality of light-emitting devices 111 to prevent a change in the position of the light-emitting device 111. Further, the substrate 112 may supply power, which is for the light-emitting device 111 to emit light, to the light-emitting device 111.

The substrate 112 may fix the plurality of light-emitting devices 111 and may be configured with synthetic resin and/or tempered glass and/or a printed circuit board (PCB) on which a conductive power supply line for supplying power to the light-emitting device 111 is formed.

Further, the substrate 112 may include a plurality of sub-substrates 112′.

The reflective sheet 120 may reflect light emitted from the plurality of light-emitting devices 111 to the front side or in a direction close to the front side.

In the reflective sheet 120, a plurality of through holes 120a is formed at positions corresponding to each of the plurality of light-emitting devices 111 of the light source module 110. In addition, the light-emitting device 111 of the light source module 110 may pass through the through hole 120a and protrude to the front of the reflective sheet 120.

For example, in a process of assembling the reflective sheet 120 and the light source module 110, the plurality of light-emitting devices 111 of the light source module 110 is inserted into the through holes 120a formed on the reflective sheet 120. Accordingly, the substrate 112 of the light source module 110 may be disposed behind the reflective sheet 120, but the plurality of light-emitting devices 111 of the light source module 110 may be disposed in front of the reflective sheet 120.

Accordingly, the plurality of light-emitting devices 111 may emit light in front of the reflective sheet 120.

The plurality of light-emitting devices 111 may emit light in various directions in front of the reflective sheet 120. The light may be emitted not only toward the diffuser plate 130 from the light-emitting device 111, but also toward the reflective sheet 120 from the light-emitting device 111. The reflective sheet 120 may reflect light, which is emitted toward the reflective sheet 120, toward the diffuser plate 130.

Light emitted from the light-emitting device 111 may pass through various objects, such as the diffuser plate 130 and the optical sheet 140. Among incident light rays passing through the diffuser plate 130 and the optical sheet 140, some of the incident light rays may be reflected from surfaces of the diffuser plate 130 and the optical sheet 140. The reflective sheet 120 may reflect light which is reflected by the diffuser plate 130 and the optical sheet 140.

The diffuser plate 130 may be provided in front of the light source module 110 and the reflective sheet 120, and may evenly distribute the light emitted from the light-emitting device 111 of the light source module 110.

As described above, the plurality of light-emitting devices 111 may be disposed in various places on the rear surface of the backlight unit 100. Although the plurality of light-emitting devices 111 are disposed at equal intervals on the rear surface of the backlight unit 100, luminance non-uniformity may occur depending on the positions of the plurality of light-emitting devices 111.

Within the diffuser plate 130, the diffuser plate 130 may diffuse light emitted from the plurality of light-emitting devices 111 to remove luminance non-uniformity caused by the plurality of light-emitting devices 111. In other words, the diffuser plate 130 may uniformly emit non-uniform light of the plurality of light-emitting devices 111 to the front surface.

The optical sheet 140 may include various sheets for improving luminance and luminance uniformity. For example, the optical sheet 140 may include a diffusion sheet 141, a first prism sheet 142, a second prism sheet 143, and a reflective polarizing sheet 144.

The diffusion sheet 141 may diffuse light for the luminance uniformity. The light emitted from the light-emitting device 111 may be diffused by the diffuser plate 130 and may be diffused again by the diffusion sheet 141 included in the optical sheet 140.

The first and second prism sheets 142 and 143 may increase the luminance by condensing light diffused by the diffusion sheet 141. The first and second prism sheets 142 and 143 may include a prism pattern in the shape of a triangular prism, and the prism pattern, which is provided in plurality, may be disposed adjacent to each other to form a plurality of strips.

The reflective polarizing sheet 144 is a type of polarizing film and may transmit some of the incident light rays and reflect others for improving the luminance. For example, the reflective polarizing sheet 144 may transmit light polarized in the same direction as a predetermined polarization direction of the reflective polarizing sheet 144, and may reflect light polarized in a direction different from the polarization direction of the reflective polarizing sheet 144. In addition, the light reflected by the reflective polarizing sheet 144 is recycled inside the backlight unit 100, and thus the luminance of the display apparatus 10 may be improved by the light recycling.

The optical sheet 140 is not limited to the sheet or film shown in FIG. 4, and may include more various sheets, such as a protective sheet, or films.

The backlight unit 100 may include the plurality of light-emitting devices (the plurality of light sources) 111, and may output surface light by diffusing light emitted from the plurality of light-emitting devices 111. The liquid crystal panel 20 may include the plurality of pixels, and control the plurality of pixels to allow each of the plurality of pixels to transmit or block light. An image may be formed by light passing through each of the plurality of pixels.

In this instance, the display apparatus 10 may perform local dimming to vary the brightness of light in each region of the backlight unit 100 in conjunction with the output image so as to improve power consumption while increasing the contrast ratio.

For example, the display apparatus 10 may reduce the brightness of the light of the light-emitting device 111 of the backlight unit 100 corresponding to a dark portion of the image so as to make the dark portion of the image darker, and may increase the brightness of the light of the light-emitting device 111 of the backlight unit 100 corresponding to a bright portion of the image so as to make the bright portion of the image brighter. As a result, the contrast ratio or brightness ratio of the image may be improved.

The display apparatus 10 divides the backlight unit 100 into a plurality of blocks, and independently controls a current for each block according to an input image. The image transmission of the display apparatus 10 is performed by a method of local dimming driving for each frame, and driving of the current is controlled according to the number of blocks of the light-emitting devices 111 divided in the backlight unit 100.

As a result, the display apparatus 10 may effectively improve the contrast ratio by reducing a supply current to a dimming block corresponding to a dark region of the input image and increasing a supply current to a dimming block corresponding to a bright region of the input image.

For the local dimming, the plurality of light-emitting devices 111 included in the backlight unit 100 may be classified into a plurality of dimming blocks 200. For example, the plurality of dimming blocks 200 may be arranged in 5 rows and 12 columns, for a total of 60, as shown in FIG. 5. As another example, the plurality of dimming blocks 200 may be arranged in 5 rows and 4 columns, for a total of 20. However, the number of dimming blocks 200 is not limited to the above example.

Referring to FIG. 5, each of the plurality of dimming blocks 200 may include at least one light-emitting device 111. The backlight unit 100 may supply the same driving current to the light-emitting devices 111 belonging to the same dimming block 200, and the light-emitting devices 111 belonging to the same dimming block 200 may emit light of the same brightness.

In addition, the backlight unit 100 may supply different driving currents to the light-emitting devices 111 belonging to different dimming blocks 200 according to dimming data, and the light-emitting devices 111 belonging to different dimming blocks 200 may emit light of different brightness.

Each of the plurality of dimming blocks 200 may include N*M light sources arranged in an N*M matrix form (N and M are natural numbers). An N*M matrix refers to a matrix having N rows and M columns.

Each of light-emitting devices 111 may include an LED, and thus each of the plurality of dimming blocks 200 may include N*M LEDs.

The plurality of dimming blocks 200 may be arranged on the substrate 112. That is, N*M LEDs may be arranged on the substrate 112. Alternatively, the plurality of dimming blocks 200 may be provided on each of the plurality of sub-substrates 112′ included in the substrate 112.

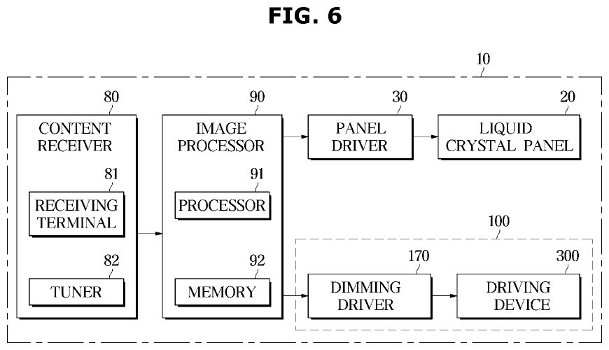

FIG. 6 illustrates a control block diagram of the display apparatus according to an embodiment.

Referring to FIG. 6, the display apparatus 10 may include a content receiver 80, an image processor 90, the panel driver 30, the liquid crystal panel 20, and the backlight unit 100. In this instance, the backlight unit 100 may include a dimming driver 170 configured to perform local dimming and a driving device 300 configured to drive the light-emitting device 111. The driving device 300 may be disposed on an upper surface or a lower surface of the substrate 112.

The content receiver 80 may include a receiving terminal 81 and a tuner 82 that receive a content including video signals and/or audio signals from content sources.

The receiving terminal 81 may receive video signals and audio signals from the content sources through a cable. For example, the receiving terminal 81 may include a component (YPbPr/RGB) terminal, a composite video blanking and sync (CVBS) terminal, an audio terminal, a High-Definition Multimedia Interface (HDMI) terminal, a Universal Serial Bus (USB) terminal, and the like.

The tuner 82 may receive a broadcast signal from a broadcast reception antenna or a wired cable. Further, the tuner 82 may extract a broadcast signal of a channel selected by a user from broadcast signals. For example, the tuner 82 may transmit a broadcast signal having a frequency corresponding to the channel selected by a user among a plurality of broadcast signals received through the broadcast reception antenna or the wired cable, and block a broadcast signal having a different frequency.

As such, the content receiver 80 may receive an image including video signals and audio signals from content sources through the receiving terminal 81 and/or the tuner 82. The content receiver 80 may output the input image, which is received through the receiving terminal 81 and/or the tuner 82, to the image processor 90.

The image processor 90 may include at least one processor 91 configured to process an input image (image data), and a memory 92 configured to memorize/store data.

The memory 92 may store programs and data for processing video signals and/or audio signals. Further, the memory 92 may temporarily store data that is generated in processing video signals and/or audio signals.

The memory 92 may include a non-volatile memory such as read only memory (ROM) and flash memory, and a volatile memory such as static random access memory (S-RAM) and dynamic random access memory (D-RAM).

The at least one processor 91 may receive an input image including video signals and/or audio signals from the content receiver 80. The processor 91 may decode the video signal into image data. The processor 91 may generate dimming data from the image data. Further, the processor 91 may output image data and dimming data to the panel driver 30 and the dimming driver 170, respectively.

The at least one processor 91 may provide dimming data for local dimming to the backlight unit 100. The dimming data may include information about a luminance of each of the plurality of dimming blocks 200. For example, the dimming data may include information about an intensity of light output by the light-emitting devices 111 included in each of the plurality of dimming blocks 200. That is, the dimming data may include information about an intensity of a current supplied to the light-emitting devices 111 included in each of the plurality of dimming blocks 200.

The at least one processor 91 may obtain dimming data from image data decoded from a video signal.

The at least one processor 91 may convert image data into dimming data in various ways. For example, the at least one processor 91 may divide the image I based on image data into a plurality of image blocks. The number of plurality of image blocks may be equal to the number of plurality of dimming blocks 200, and each of the plurality of image blocks may correspond to the plurality of dimming blocks 200.

The at least one processor 91 may obtain a luminance value of the plurality of dimming blocks 200 from the image data of the plurality of image blocks. Further, the processor 91 may generate dimming data by combining the luminance values of the plurality of dimming blocks 200.

For example, the at least one processor 91 may obtain a luminance value of each of the plurality of dimming blocks 200 based on a maximum value among luminance values of pixels included in each image block.

A single image block may include a plurality of pixels, and image data of the single image block may include image data of a plurality of pixels (for example, red data, green data, blue data, and the like). The at least one processor 91 may calculate the luminance value of each pixel based on the image data of each pixel.

The at least one processor 91 may set a maximum value among the luminance values of each pixel included in the image block as a luminance value of the dimming block corresponding to the image block. For example, the processor 91 may set a maximum value among luminance values of pixels included in a first image block as a luminance value of a first dimming block, and set a maximum value among luminance values of pixels included in a second image block as a luminance value of a second dimming block.

The at least one processor 91 may generate dimming data by combining the luminance values of the plurality of dimming blocks 200.

As described above, the at least one processor 91 may decode the video signal obtained by the content receiver 80 into image data, and generate dimming data from the image data. Further, the at least one processor 91 may transmit image data and dimming data to the liquid crystal panel 20 and the backlight unit 100, respectively.

That is, the at least one processor 91 may decode an input image received via the content receiver 80 into image data, and generate dimming data corresponding to the input image from the image data. In this instance, the dimming driver 170 of the backlight unit 100 may convert the dimming data received from the image processor 90 into a dimming signal indicating the magnitude of current to be supplied to the light-emitting device 111 of each of the dimming blocks 200, thereby controlling the driving device 300.

As such, the at least one processor 91 may divide a plurality of light-emitting devices 111 into a plurality of dimming blocks 200, and control the supply current for each dimming block 200 based on the dimming signal corresponding to the input image.

According to embodiments, in a case where a plurality of power lines are provided, the at least one processor 91 may control the dimming driver 170 to supply driving voltages in a time-division manner via a plurality of power lines.

For example, in a case where a first power line supplies power to each of odd-numbered rows in the array of the plurality of dimming blocks 200, and a second power line supplies power to each of even-numbered rows in the array of the plurality of dimming blocks 200, the at least one processor 91 may control voltage supplied through the first and second power lines in a time-division manner. Specifically, the at least one processor 91 may control the dimming driver 170 such that voltage is alternately applied to the first power line and the second power line.

The liquid crystal panel 20 includes a plurality of pixels capable of transmitting or blocking light, and the plurality of pixels are arranged in a matrix shape. In other words, the plurality of pixels may be arranged in a plurality of rows and a plurality of columns.

The panel driver 30 may receive image data from the image processor 90. The panel driver 30 may drive the liquid crystal panel 20 according to the image data. In other words, the panel driver 30 may convert image data, which is a digital signal (hereinafter referred to as ‘digital image data’), into an analog image signal, which is an analog voltage signal. The panel driver 30 may provide the analog image signal to the liquid crystal panel 20. Optical properties (e.g., light transmittance) of the plurality of pixels included in the liquid crystal panel 20 may change according to the analog image signal.

The panel driver 30 may include a timing controller, a data driver, a scan driver, and the like.

The timing controller may receive image data from the image processor 90. The timing controller may output image data and a drive control signal to the data driver and the scan driver. The drive control signal may include a scan control signal and a data control signal. The scan control signal and the data control signal may be used to control the operation of the scan driver and the data driver, respectively.

The scan driver may receive a scan control signal from the timing controller. The scan driver may activate input of any one row among the plurality of rows in the liquid crystal panel 20 according to the scan control signal. In other words, the scan driver may convert a pixel, which is included in one row among the plurality of pixels arranged in the plurality of rows and the plurality of columns, into a state capable of receiving an analog image signal. In this instance, pixels, which are input-deactivated, other than pixels in which the input is activated by the scan driver may not receive the analog image signal.

The data driver may receive image data and data control signals from the timing controller. The data driver may output image data to the liquid crystal panel 20 according to the data control signal. For example, the data driver may receive digital image data from the timing controller. The data driver may convert digital image data into analog image signals. Further, the data driver may provide an analog image signal to pixels included in any one input-activated row by the scan driver. In this instance, pixels in which the input is activated by the scan driver may receive analog image signals. Optical properties (e.g., light transmittance) of input-activated pixels change according to the received analog image signal.

As such, the panel driver 30 may drive the liquid crystal panel 20 according to image data. Accordingly, an image corresponding to the image data may be displayed on the liquid crystal panel 20.

The dimming driver 170 may receive dimming data from the image processor 90 and drive the backlight unit 100 according to the dimming data. The dimming data may include information about luminance of each of the plurality of dimming blocks 200, information about brightness of the light-emitting device 111 included in each of the plurality of dimming blocks 200, or information about a magnitude of current supplied to the light-emitting device 111 included in each of the plurality of dimming blocks 200.

The dimming driver 170 may convert dimming data, which is a digital signal (hereinafter referred to as “digital dimming data”), into an analog dimming signal, which is an analog voltage signal, and provide the analog dimming signal to the dimming block 200. According to the analog dimming signal, the driving device 300 may adjust the magnitude of current supplied to the light-emitting device 111 included in each of the plurality of dimming blocks 200, thereby changing an intensity of light emitted by the light-emitting device 111.

Particularly, the dimming driver 170 may sequentially provide analog dimming signals to the plurality of dimming blocks 200 in an active-matrix manner or passive-matrix manner, rather than directly providing analog dimming signals to all of the plurality of dimming blocks 200.

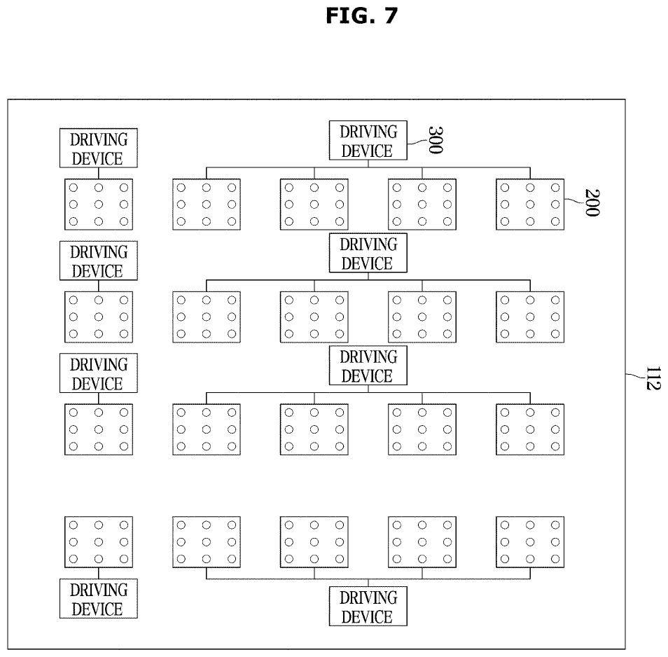

As described above, the plurality of dimming blocks 200 may be arranged in a matrix form in the backlight unit 100. In other words, as shown in FIG. 7, the plurality of dimming blocks 200 may be arranged in a plurality of rows and a plurality of columns on the substrate 112.

The dimming driver 170 may sequentially provide an analog dimming signal to dimming blocks belonging to each of a plurality of rows, or sequentially provide an analog dimming signal to dimming blocks belonging to each of a plurality of columns.

For example, the dimming driver 170 may activate input of dimming blocks belonging to one row among the plurality of dimming blocks 200 and provide an analog dimming signal to the input-activated dimming blocks. Thereafter, the dimming driver 170 may activate input of dimming blocks belonging to another row among the plurality of dimming blocks 200 and provide an analog dimming signal to the input-activated dimming blocks.

The display apparatus 10 may include the dimming driver 170, the plurality of driving devices 300, and the plurality of light-emitting devices 111.

Each of the plurality of dimming blocks 200 may include a defined number of light-emitting devices 111. For example, as shown in FIG. 7, each of the plurality of dimming blocks 200 may include nine light-emitting devices 111 (as light-emitting diodes).

The plurality of driving devices 300 may receive analog dimming signals from the dimming driver 170, and supply driving current to the plurality of dimming blocks 200 according to the received analog dimming signal.

Hereinafter, an improved arrangement of the plurality of dimming blocks 200 driven by each of the plurality of driving devices 300 and a change in the driving method will be described.

FIG. 7 illustrates an example of an arrangement of dimming blocks driven by each driving device according to an embodiment.

Referring to FIG. 7, as an example, the plurality of dimming blocks 200 may be provided in a total of 20, consisting of five rows and four columns on the substrate 112. In addition, the substrate 112 may include the plurality of sub-substrates 112′, and the twenty dimming blocks 200 may be provided on the sub-substrate 112′, respectively.

In such an arrangement of the dimming blocks 200, in the case of active matrix and passive matrix systems, the plurality of dimming blocks 200 arranged in the same scan line, i.e., in the same row, are required to be driven simultaneously, and thus the plurality of dimming blocks 200 included in a single column are generally arranged to be driven by one driving device 300.

That is, as shown in FIG. 7, one driving device 300 may drive four dimming blocks 200 arranged in four rows and one column.

In the arrangement where the plurality of dimming blocks 200 are arranged in five rows and four columns on the substrate 112 as shown in FIG. 7, each of the four dimming blocks 200 located in the bottom row is driven by one driving device 300.

In this case, although one driving device 300 may drive four dimming blocks 200 arranged in four rows and one column, one driving device 300 is limited to driving only one dimming block 200 due to the arrangement limitations.

That is, depending on the arrangement of the plurality of dimming blocks 200 on the substrate 112 and the arrangement of the plurality of dimming blocks 200 driven by each of the plurality of driving devices 300, the number of driving devices 300 may increase.

Accordingly, the number of driving devices 300 may be reduced using the improved arrangement to simplify the wiring and reduce the cost.

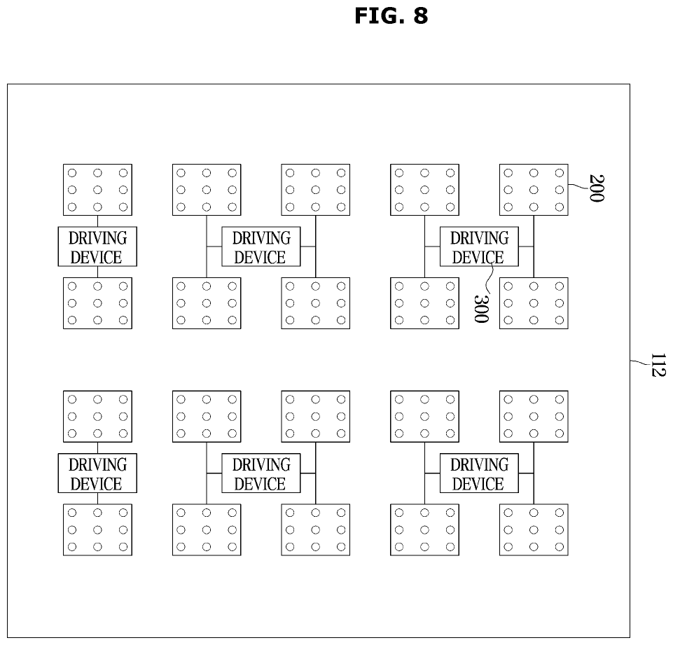

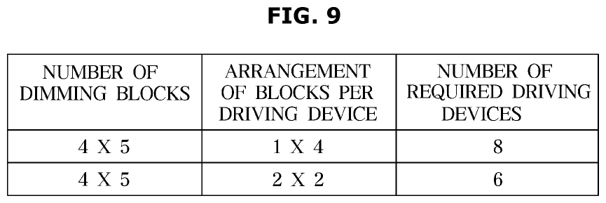

FIG. 8 illustrates an example of an improved arrangement of dimming blocks driven by each driving device according to an embodiment. FIG. 9 illustrates the number of driving devices required according to an arrangement of dimming blocks driven by each driving device.

In order to prevent an increase in the number of driving devices 300 when one driving device 300 is arranged to drive the plurality of dimming blocks 200 arranged in the same column as described above, each of the plurality of driving devices 300 may be arranged to drive at least two dimming blocks 200 arranged in different columns.

That is, as shown in FIG. 8, one driving device 300 may be arranged to drive four dimming blocks 200 arranged in two adjacent rows and two adjacent columns.

That is, each of the plurality of driving devices 300 may supply driving current to four dimming blocks 200 arranged in two adjacent rows and two adjacent columns.

In the arrangement where the plurality of dimming blocks 200 are arranged in five rows and four columns on the substrate 112 as shown in FIG. 8, six driving devices 300 are required, and thus the number of driving devices 300 required may be reduced compared to the case where one driving device 300 drives four dimming blocks 200 arranged in four rows and one column.

In addition, one driving device 300 may be arranged to drive six dimming blocks 200 arranged in three adjacent rows and two adjacent columns. That is, each of the plurality of driving devices 300 may supply driving current to four dimming blocks 200 arranged in three adjacent rows and two adjacent columns. In this case, four driving devices 300 are required, and thus the number of driving devices 300 required to drive the plurality of dimming blocks 200 on the substrate 112 may be further reduced.

By arranging each of the plurality of driving devices 300 to drive the dimming blocks 200 arranged in different columns as described above, the number of driving devices 300 required may be reduced.

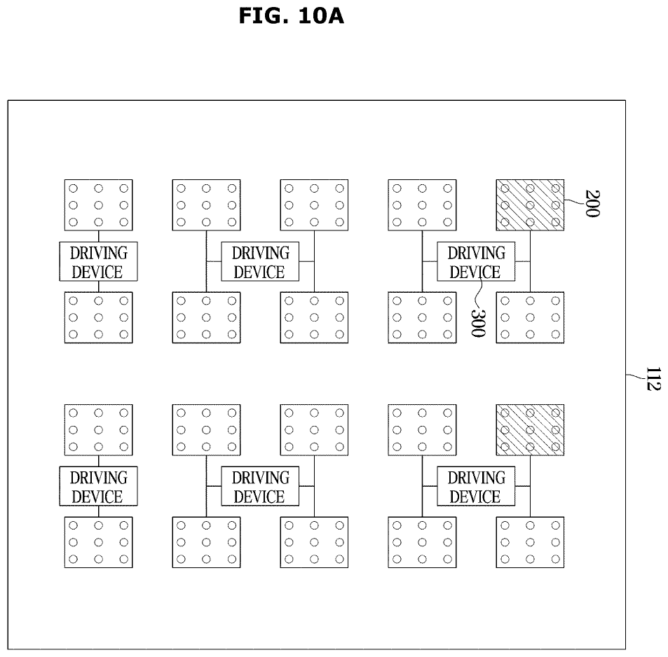

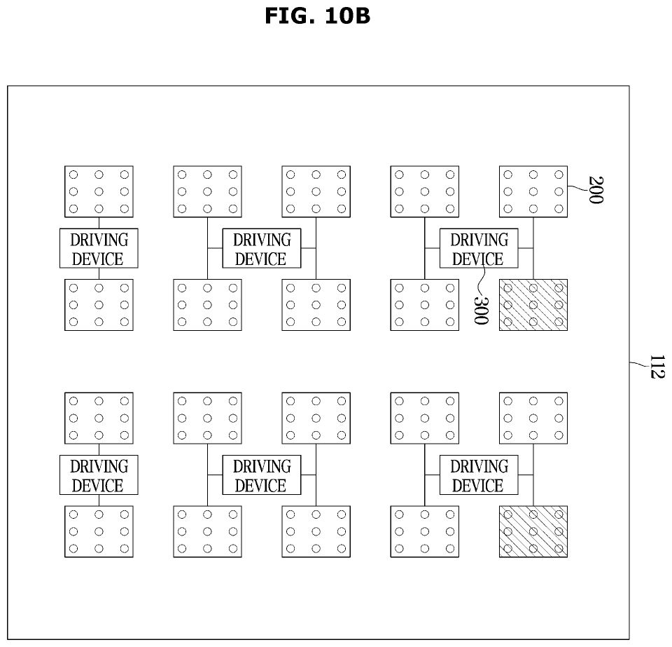

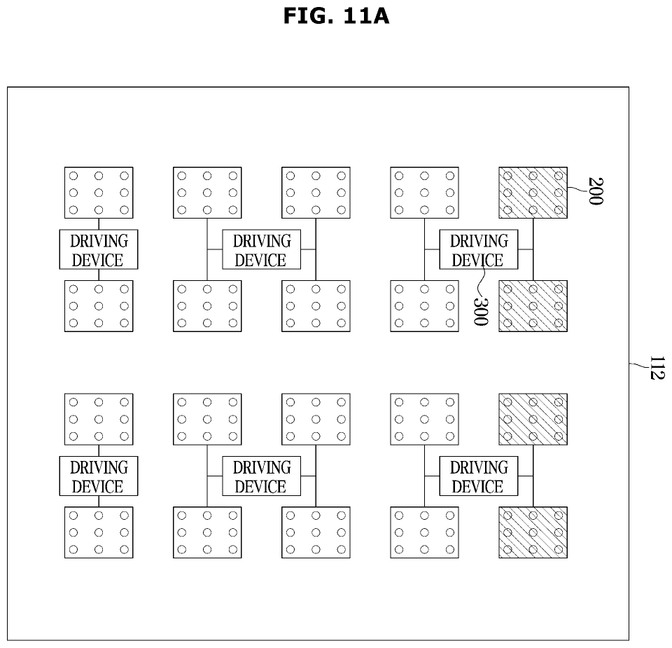

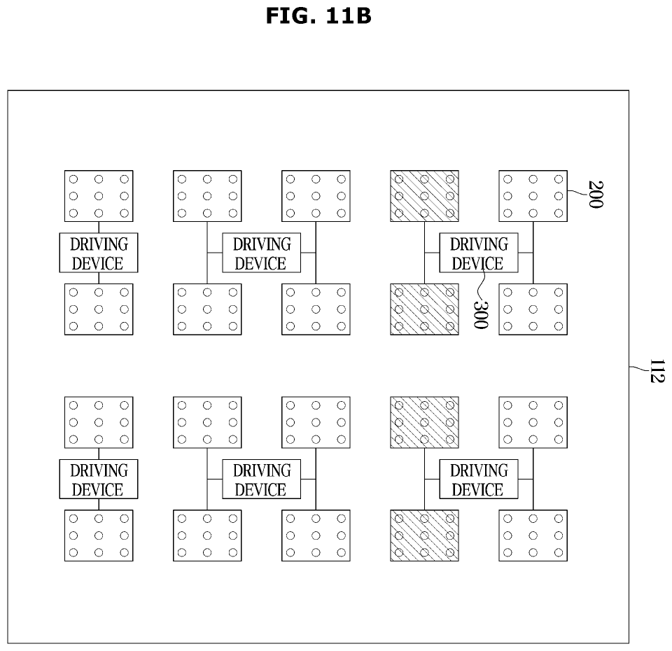

FIG. 10 illustrates that dimming blocks in an improved arrangement are driven according to a sequential driving method according to an embodiment. FIG. 11 illustrates that dimming blocks in the same row are driven simultaneously according to an embodiment

Hereinafter, the description will be made assuming the case where one driving device 300 is arranged to drive four dimming blocks 200 arranged in two adjacent rows and two adjacent columns from among the improved arrangements according to an embodiment of the disclosure.

FIG. 10 illustrates that one driving device 300 drives the dimming blocks 200 in one column at a time according to a sequential driving system.

In this case, as shown in FIG. 10A, the plurality of dimming blocks 200 included in the first row are not driven simultaneously. The dimming block 200 arranged in the first row and the first column and the dimming block 200 arranged in the first row and the third column are driven first.

Thereafter, as shown in FIG. 10B, the dimming block 200 arranged in the first row and the second column and the dimming block 200 arranged in the first row and the fourth column may be driven.

Thereafter, the dimming block 200 arranged in the second row and the first column and the dimming block 200 arranged in the second row and the third column may be driven, and then the dimming block 200 arranged in the second row and the second column and the dimming block 200 arranged in the second row and the fourth column may be driven.

By driving the dimming blocks 200 in the above driving method, the plurality of dimming blocks 200 included in the same row are not turned on simultaneously, which may cause image quality deterioration.

To prevent such image quality deterioration, the plurality of driving devices 300 may be controlled so that the plurality of dimming blocks 200 arranged in the same row are driven simultaneously.

That is, among the plurality of dimming blocks 200 arranged in two rows and two columns and driven by one driving device 300, two dimming blocks 200 arranged in the same row may be driven to be turned on simultaneously.

According to the above driving method, as shown in FIG. 11A, the plurality of dimming blocks 200 arranged in the first row may be driven simultaneously.

Thereafter, as shown in FIG. 11B, the plurality of dimming blocks 200 arranged in the second row may be driven simultaneously, and thus the plurality of dimming blocks 200 arranged in different rows may be sequentially driven.

By controlling the plurality of dimming blocks 200 arranged in the same row to be driven simultaneously and the plurality of dimming blocks 200 arranged in different rows to be sequentially driven as described above, image quality deterioration may be prevented.

According to an embodiment of the disclosure, a display apparatus may include: a substrate; a plurality of dimming blocks arranged in a plurality of rows and a plurality of columns on the substrate, each of the plurality of dimming blocks including a plurality of light-emitting devices; a plurality of driving devices configured to drive at least two of the plurality of dimming blocks; and at least one processor configured to control the plurality of driving devices, wherein each of the plurality of driving devices is configured to drive at least two dimming blocks arranged in different columns, and the at least one processor is configured to control the plurality of driving devices to drive a plurality of dimming blocks arranged in a single row (e.g., the same row) simultaneously.

According to the disclosure, by arranging dimming blocks driven by a single driving device in different columns, the number of driving devices may be reduced, wiring may be simplified, and cost may be reduced. Further, image quality deterioration may be prevented by driving dimming blocks arranged in the same row simultaneously.

The at least one processor may be configured to control the plurality of driving devices to sequentially drive the plurality of dimming blocks arranged in different rows.

The at least one processor may be configured to control the plurality of driving devices to drive a plurality of dimming blocks arranged in a first row simultaneously, and then to drive a plurality of dimming blocks arranged in a second row adjacent to the first row simultaneously.

Each of the plurality of driving devices may be configured to drive four dimming blocks arranged in two adjacent columns and two adjacent rows.

Each of the plurality of driving devices may be configured to supply a driving current to the four dimming blocks arranged in two adjacent columns and two adjacent rows.

Each of the plurality of driving devices may be configured to drive six dimming blocks arranged in two adjacent columns and three adjacent rows.

Each of the plurality of driving devices may be configured to supply a driving current to the six dimming blocks arranged in two adjacent columns and three adjacent rows.

The driving device is disposed on an upper surface or a lower surface of the substrate.

Each of the plurality of dimming blocks may include a defined number of light-emitting devices.

According to an embodiment of the disclosure, a display apparatus may include: a substrate including a plurality of sub-substrates; a plurality of dimming blocks arranged in a plurality of rows and a plurality of columns on each of the plurality of sub-substrates, each of the plurality of dimming blocks including a plurality of light-emitting devices; a plurality of driving devices configured to drive at least two of the plurality of dimming blocks; and at least one processor configured to control the plurality of driving devices, wherein each of the plurality of driving devices may be configured to drive at least two dimming blocks arranged in different columns, and the at least one processor may be configured to control the plurality of driving devices to drive a plurality of dimming blocks arranged in a single row simultaneously, and to sequentially drive the plurality of dimming blocks arranged in different rows.

According to the disclosure, by arranging dimming blocks driven by a single driving device in different columns, the number of driving devices may be reduced, wiring may be simplified, and cost may be reduced. Further, image quality deterioration may be prevented by driving dimming blocks arranged in the same row simultaneously.

The disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

Embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments described above are merely for illustrative purposes and not for limitation purposes in all aspects.

What is claimed is:

1. A display apparatus comprising:
a substrate;
a plurality of dimming blocks arranged in a plurality of rows and a plurality of columns on the substrate, each of the plurality of dimming blocks comprising a plurality of light-emitting devices;
a plurality of driving devices configured to drive at least two of the plurality of dimming blocks, wherein each of the plurality of driving devices is configured to drive at least two dimming blocks arranged in different columns;
memory storing instructions; and
at least one processor configured to control the plurality of driving devices,
wherein the instructions, when executed by the at least one processor individually or collectively, cause the at least one processor to control the plurality of driving devices to drive the plurality of dimming blocks arranged in a single row simultaneously.

2. The display apparatus of claim 1, wherein the instructions, when executed by the at least one processor individually or collectively, cause the at least one processor to control the plurality of driving devices to sequentially drive dimming blocks of the plurality of dimming blocks arranged in different rows.

3. The display apparatus of claim 2, wherein the instructions, when executed by the at least one processor individually or collectively, cause the at least one processor to control the plurality of driving devices to drive a first set of dimming blocks of the plurality of dimming blocks arranged in a first row simultaneously, and, subsequent to the first set of dimming blocks arranged in the first row being simultaneously driven, drive a second set of dimming blocks of the plurality of dimming blocks arranged in a second row simultaneously, the second row being adjacent to the first row.

4. The display apparatus of claim 1, wherein each of the plurality of driving devices is configured to drive four dimming blocks arranged in two adjacent columns and two adjacent rows.

5. The display apparatus of claim 4, wherein each of the plurality of driving devices is configured to supply a driving current to the four dimming blocks arranged in the two adjacent columns and the two adjacent rows.

6. The display apparatus of claim 1, wherein each of the plurality of driving devices is configured to drive six dimming blocks arranged in two adjacent columns and three adjacent rows.

7. The display apparatus of claim 6, wherein each of the plurality of driving devices is configured to supply a driving current to the six dimming blocks arranged in the two adjacent columns and the three adjacent rows.

8. The display apparatus of claim 1, wherein each of the plurality of driving devices is disposed on an upper surface or a lower surface of the substrate.

9. The display apparatus of claim 1, wherein each of the plurality of dimming blocks comprises a defined number of light-emitting devices.

10. A display apparatus comprising:
a substrate comprising a plurality of sub-substrates;
a plurality of dimming blocks arranged in a plurality of rows and a plurality of columns on each of the plurality of sub-substrates, each of the plurality of dimming blocks including a plurality of light-emitting devices;
a plurality of driving devices configured to drive at least two of the plurality of dimming blocks, wherein each of the plurality of driving devices is configured to drive at least two dimming blocks arranged in different columns;
memory storing instructions; and
at least one processor configured to control the plurality of driving devices,
wherein the instructions, when executed by the at least one processor individually or collectively, cause the at least one processor to control the plurality of driving devices to:
drive the plurality of dimming blocks arranged in a single row of the plurality of rows simultaneously, and
sequentially drive the plurality of dimming blocks arranged in different rows.

11. The display apparatus of claim 10, wherein each of the plurality of driving devices is configured to drive four dimming blocks arranged in two adjacent columns and two adjacent rows.

12. The display apparatus of claim 11, wherein each of the plurality of driving devices is configured to supply a driving current to the four dimming blocks arranged in the two adjacent columns and the two adjacent rows.

13. The display apparatus of claim 10, wherein each of the plurality of driving devices is configured to drive six dimming blocks arranged in two adjacent columns and three adjacent rows.

14. The display apparatus of claim 13, wherein each of the plurality of driving devices is configured to supply a driving current to the six dimming blocks arranged in the two adjacent columns and the three adjacent rows.

15. The display apparatus of claim 10, wherein each of the plurality of driving devices is disposed on an upper surface or a lower surface of the substrate.

16. The display apparatus of claim 10, wherein each of the plurality of dimming blocks comprises a defined number of light-emitting devices.

17. A method for sequentially driving a plurality of dimming blocks arranged in a plurality of rows on a substrate of a display apparatus, the method comprising:
driving dimming blocks of a plurality of dimming blocks arranged in a first row simultaneously; and
subsequent to the dimming blocks arranged in the first row being simultaneously driven, drive dimming blocks of the plurality of dimming blocks arranged in a second row simultaneously,
wherein the plurality of dimming blocks are driven by a plurality of driving devices.

18. The method of claim 17, wherein the dimming blocks arranged in the first row are simultaneously driven by a first set of the plurality of driving devices.

19. The method of claim 17, wherein the second row is adjacent to the first row.

20. The method of claim 17, wherein each of the plurality of dimming blocks comprises a plurality of light-emitting devices.
